(19) United States
(12) Patent Application Publication
(10) Pub. No.: US 2020/0049586 A1
(43) Pub. Date: Feb. 13, 2020

(54) METHOD FOR CHECKING THE FUNCTIONAL CAPABILITY OF THE THERMAL INSULATION OF A TRANSPORT CONTAINER

(71) Applicant: VA-Q-TEC AG, Würzburg (DE)

(72) Inventors: Fabian ESCHENBACH, Rottendorf (DE); Martin HEINEMANN, Lauingen (DE); Thomas TARASCHEWSKI, Würzburg (DE); Joachim KUHN, Würzburg (DE)

(21) Appl. No.: 16/486,019

(22) PCT Filed: Feb. 28, 2018
(86) PCT No.: PCT/EP2018/054948

§ 371 Date: Aug. 14, 2019

(30) Foreign Application Priority Data
Mar. 1, 2017 (DE) 10 2017 001 865.0

(51) Int. Cl. G01M 3/32

(52) U.S. Cl. CPC G01M 3/3272

(57) ABSTRACT

The invention relates to a method for checking the functional capability of the thermal insulation of a transport container, at least one vacuum insulation panel being installed in the thermal insulation of the transport container, which vacuum insulation panel consists of a porous core material of low thermal conductivity and a gas-tight casing, which surrounds the core material in a tightly contacting manner at very low internal pressure, and which vacuum insulation panel has a pressure sensor and a transponder connected to the pressure sensor within the casing, the transponder being controlled for checking by means of an external reading device from outside the thermal insulation and the response signal of the transponder being captured (read out) and the response signal being evaluated with respect to whether the internal pressure in the vacuum insulation panel is correctly low or incorrectly high. Said method is characterized in that the external reading device can be moved and, while the transport container stands still or is moved in a controlled manner, the external reading device is moved to a specified position relative to the transport container in an automated, motorized manner, said position being suitable for reading out the transponder, that the response signal of the transponder is captured there and that the captured response signal of the transponder is electronically evaluated in an automated manner.

The present invention relates to a method for checking the functional capability of the thermal insulation of a transport container having the features of the precharacterizing clause of claim 1 and having the features of the precharacterizing clause of claim 6. The invention also relates to apparatuses for carrying out corresponding methods.

Vacuum insulation panels have often been installed in the meantime in the thermal insulation of high-quality transport containers. A vacuum insulation panel generally consists of an evacuable porous core with very low thermal conductivity and a vacuum-tight enclosure, preferably a metallized high-barrier film, often in multiple layers using plastic. Microporous silica powder has proved itself as the core material for applications in which a long service life is important. Open-pore foams such as polyurethane or polystyrene can be used as the core material for other applications. Specifically, reference can be made here to the prior art from DE 102 15 213 C1.

An insulating function of the vacuum insulation panel is provided only if the enclosure is not damaged. The initial gas pressure in the core of the vacuum insulation panel is typically between 0.1 and 1 mbar. If the enclosure is not damaged, the increase in the gas pressure is often only in the range of 1 to 2 mbar per year.

In order to check the gas pressure in the core of a vacuum insulation panel, it is known practice (DE 102 15 213 C1), for example, to arrange a metal disk, on which a thin fiberglass mat is situated, between the enclosure and the core. A measuring head can be fitted here from the outside at increased temperature. The heat transfer is dependent on the gas pressure inside the enclosure of the vacuum insulation panel. This makes it possible to measure the gas pressure inside the enclosure.

The method known from the prior art explained above cannot be used where the vacuum insulation panel is installed in the thermal insulation, for example in a transport container.

The vacuum insulation panel is then no longer accessible from the outside. In order to check the functional capability of the vacuum insulation panel in the installed state in the thermal insulation of a transport container, it has therefore been proposed (DE 10 2006 042 426 B4) to operate using RFID technology. In this case, an RFID transponder is installed inside the enclosure of the vacuum insulation panel together with a pressure sensor, for example a micromechanical pressure sensor, which is likewise arranged directly on the enclosure inside the enclosure. Depending on the pressure difference between the ambient atmosphere and the interior of the vacuum insulation panel, the pressure sensor has a different switching state which can be captured from the outside via the RFID transponder using a reader. This makes it possible to obtain information relating to whether the vacuum insulation panel installed in the thermal insulation of the transport container is functional or is ventilated and is therefore no longer functional.

Enclosures having metal individual layers or coatings, in particular having aluminum foils, are particularly expedient with respect to the gas tightness but, on account of the metal, have a relatively strong shielding effect for RFID transponders. Pure plastic films are more expedient in terms of metrology in this respect but have a lower efficiency with respect to the gas tightness and are sometimes also more difficult to process. In this respect, many variants which enable corresponding tuning are also known in the prior art (DE 10 2006 042 426 B4, DE 101 17 021 A1).

By accordingly designing the RFID transponder and using an appropriate external reader, the check can be carried out at a sufficient distance from the installation location of the vacuum insulation panel, typically at a distance of between 5 and 20 cm. The functional capability of the vacuum insulation panel in the installed state can therefore be checked. In addition, depending on the design of the RFID transponder, an identification number for the specific vacuum insulation panel or another item of information can also be transmitted, for example.

In the prior art, the functional capability of the thermal insulation of the transport container is manually checked by an operator. A total of six vacuum insulation panels, namely four in the side walls and one each in the base and the cover, are often installed in a high-quality transport container intended for transporting valuable temperature-sensitive goods. The manual check by an operator using an appropriate handheld reader requires several minutes for each transport container. This is unsuitable for larger production quantities.

The teaching is therefore based on the problem of configuring and developing the known method for checking the functional capability of the thermal insulation of a transport container in such a manner that it can be expediently used for larger production quantities.

In the case of a method having the features of the precharacterizing clause of claim 1, the problem shown above is solved by means of the features of the characterizing part of claim 1. Dependent claims 2 to 5 relate to preferred configurations and developments.

The invention provides for the external reader to be able to be moved and, if the transport container is stationary or is moving in a controlled manner, to be moved to a predefined position relative to the transport container in an automated and motorized manner, which position is suitable for reading the transponder, for the response signal from the transponder to be captured here, and for the captured response signal from the transponder to be electronically evaluated in an automated manner. The response signal may also here be only a yes/no signal (internal pressure in the vacuum insulation panel correct/internal pressure in the vacuum insulation panel incorrect). However, it may also be a response signal which represents a determined internal pressure in the vacuum insulation panel and is then also evaluated in terms of the assessment with respect to the functional capability of the installed vacuum insulation panel.

The transponder is preferably an RFID transponder, as has already been explained in the prior art. However, transponders, for example NFC transponders (Near Field Communication), are also possible. As in the prior art already, a micromechanical pressure sensor is recommended as the pressure sensor, but pressure sensors which operate according to another functional principle are also possible. The important factor is that the pressure sensor, together with the transponder, constitutes the signal source for the reader which can read this signal source at an appropriate distance.

A plurality of vacuum insulation panels each with a pressure sensor and a transponder are typically installed in the thermal insulation of the transport container. In one variant of the invention, it is recommended that the transponders of all vacuum insulation panels are read at the same time or at approximately the same time using the external reader. In this case, an extended configuration of the response signal, including an identification number for the respective vacuum insulation panel, is recommended. With this extended functionality, it is not only possible to determine during reading whether at least one vacuum insulation panel is no longer functional, but rather to immediately concomitantly identify which vacuum insulation panel is no longer functional.

With the above-described method of operation of the reader for a plurality of vacuum insulation panels, there is a need for a special design of the external reader and a special procedure for moving the external reader. For example, the external reader is expediently moved in this case into the interior of the transport container, for example by means of a robot arm, when the cover is open and carries out the communication operation there.

Alternatively, provision may also be made for the transponders of all or at least a plurality of vacuum insulation panels to be read in succession by the reader. In this case, it is possible to imagine a procedure, for example, such that the external reader on a robot arm is moved, little by little, in an automated manner to the positions at which the transponder of the respective vacuum insulation panel is situated inside the thermal insulation. The sides, the base and the cover are then checked in succession.

A procedure in which a plurality of external readers are used from the outset and the transponders of different vacuum insulation panels of a transport container are simultaneously read by readers is associated with greater design complexity. It is possible to imagine, for example, that a reader according to the first method described above reads the transponders of all vacuum insulation panels of the side walls and of the base at approximately the same time and a second external reader reads the transponder of the vacuum insulation panel in the cover of the transport container.

In the procedure with automated checking of the functional capability of the thermal insulation of the transport container, it is also recommended that the transport container is transported relative to the reader(s), is preferably moved on a transport track, before and/or after reading the transponders of all vacuum insulation panels installed therein.

In particular, it is also recommended in this case that the transport container is automatically rejected after reading the transponders of all vacuum insulation panels installed therein when at least one vacuum insulation panel which is no longer functional has been identified. This can be carried out, for example, by means of a switch construction on the transport track which diverts such a transport container onto a parallel track where it can then be supplied to further processing, in particular replacement of the defective vacuum insulation panel in the thermal insulation, without the checking method for the subsequent transport containers, which takes place at high speed, having to be interrupted.

The above-described variant of claim 1 is based on an external reader which is comprehensively movable with respect to the transport container. In an alternative, which is the subject matter of claim 6 but can optionally also be combined with the method as claimed in one of claims 1 to 5, the external reader or at least one of a plurality of readers is situated on a transport track for the transport container. In this case, provision is made for the transport container to be moved to a predefined position relative to the reader in an automated manner, which position is suitable for reading the transponder, for the response signal from the transponder to be captured here, and for the captured response signal from the transponder to be electronically evaluated in an automated manner. In this case, the transport container moves on the transport track relative to the reader which is stationary on the transport track. With regard to the more or less complicated evaluation of the response signal, the same considerations as in the first variant apply.

If a plurality of vacuum insulation panels are installed in the transport container, it may be the case that the transponders in the respective vacuum insulation panel are at different positions in the transport direction of the transport container. It is then advisable for the transport container to be transported in succession in an automated manner to a plurality of different positions relative to the external reader.

A plurality of vacuum insulation panels will typically be installed in the thermal insulation of the transport container. In this respect, it is then also possible to provide for a plurality of external readers to be arranged at the transport track for the transport container, and for the transponders of different vacuum insulation panels to be simultaneously read by the readers.

In the case of transport containers, there is not always a distinction between the substructure with side walls and the base, on the one hand, and the cover, on the other hand. If vacuum insulation panels are installed everywhere, it is recommended that the transponders of the vacuum insulation panels of the substructure, on the one hand, and of the cover, on the other hand, are read separately from one another by means of a reader or a plurality of readers.

For all method variants of the method according to the invention, it may generally be advantageous if use is made of transponders which, in addition to an item of yes/no information relating to the pressure in the vacuum insulation panel, provide further data, for example a measured pressure value, a serial number or another identification of the vacuum insulation panel.

If use is made of transponders which can be comprehensively read in the manner explained above by means of a reader or a plurality of readers, provision may be made for transponders having a long range, preferably a range of more than 100 cm, to be used and for all transponders of the vacuum insulation panels of a transport container to be read together using a movable or stationary reader. This requires a special configuration of the reader.

Another variant of the method according to the invention in which use is made of transponders which, in addition to an item of yes/no information relating to the pressure in the vacuum insulation panel, provide further data, for example a measured pressure value, a serial number or another identification of the vacuum insulation panel, involves using transponders having a long range, preferably a range of more than 100 cm, arranging, in particular stacking, a plurality of transport containers together at one location, and reading together the transponders of the vacuum insulation panels of all transport containers arranged together at one location using a movable or stationary reader or using a plurality of movable or stationary readers.

In the method described last, it can be imagined that a plurality of transport containers are arranged on a pallet, for example, and are stacked in multiple layers. These transport containers can be checked all in one go with regard to the functional capability of the thermal insulation using the method according to the invention if the transponders and the reader(s) are configured accordingly.

In all of the variants of the method according to the invention explained above, it may be advisable to identify a transport container before checking the transponders of a plurality of vacuum insulation panels of the transport container in order to determine where vacuum insulation panels are installed in the thermal insulation. Only those positions which correspond to the identified positions of the vacuum insulation panels are then approached by the reader and/or only those readers which correspond to the identified positions of the vacuum insulation panels are activated for the purpose of checking the transponders. In this manner, it is certain that a correct check of the vacuum insulation panels is actually carried out for the respective transport container and no errors occur.

The prior art in DE 10 2006 042 426 B4 does not specifically state how the expedient transponder, in particular the RFID transponder, is accommodated together with the appropriate pressure sensor inside the enclosure of the vacuum insulation panel. In the case of cores which are dimensionally stable from the outset, it is obvious to arrange the corresponding chip on the outside of the core or to fasten it to the inside of the enclosure before the vacuum insulation panel is evacuated.

Modern vacuum insulation panels are nowadays often also produced in such a manner that microporous silica powder or another compressible, initially pourable powder is poured into the already largely closed enclosure and is then only compressed in the enclosure to form the dimensionally stable core. In this case, it is recommended to fit the transponder to the enclosure, but to shield it with respect to the powder with a non-woven material which, although breathable, is not permeable for the microporous powder. A corresponding situation applies to the pressure sensor. In this manner, these parts inside the enclosure remain free of soiling by the powder and can perform their function without errors.

It is generally also true that the pressure sensor, in conjunction with the transponder, is initially calibrated using the method which is based on thermal conduction and is known from the prior art (DE 102 15 213 C1) in a special vacuum insulation panel which is intended to be installed in the thermal insulation of the transport container. The vacuum insulation panel can therefore accordingly be equipped with two different systems for checking the internal pressure, wherein the known procedure based on thermal conduction is used to calibrate the pressure sensor in combination with the transponder, preferably the RFID transponder or NFC transponder. The vacuum insulation panel is therefore prepared to be able to be subjected to an exact check of the internal pressure at any time when it is accessible, whereas the transponder check within the scope of the method according to the invention is carried out when the vacuum insulation panel is installed in an inaccessible manner in the thermal insulation of the transport container.

The vacuum insulation panels are often installed in a transport container of the type in question between an outer container consisting of stable plastic and an inner container consisting of foam plastic, for example EPP. In the case of vacuum insulation panels installed in this manner, the method according to the invention can be used to check the functional capability with maximum efficiency in the run-through method and to reject transport containers with faulty thermal insulation before the transport container is used for another circulation.

The invention moreover also relates to an apparatus for carrying out a method as claimed in claim 1 and possibly as claimed in one or more further claims which refer back to claim 1. This apparatus is characterized by the features of claim 14.

Accordingly, the invention also relates to an apparatus for carrying out a method as claimed in claim 6 and possibly as claimed in one or more further claims which refer back to claim 6. This apparatus is characterized by the features of claim 15.

The invention is explained below, in conjunction with the explanation of apparatuses for carrying out the method according to the invention, using two examples. In the drawing

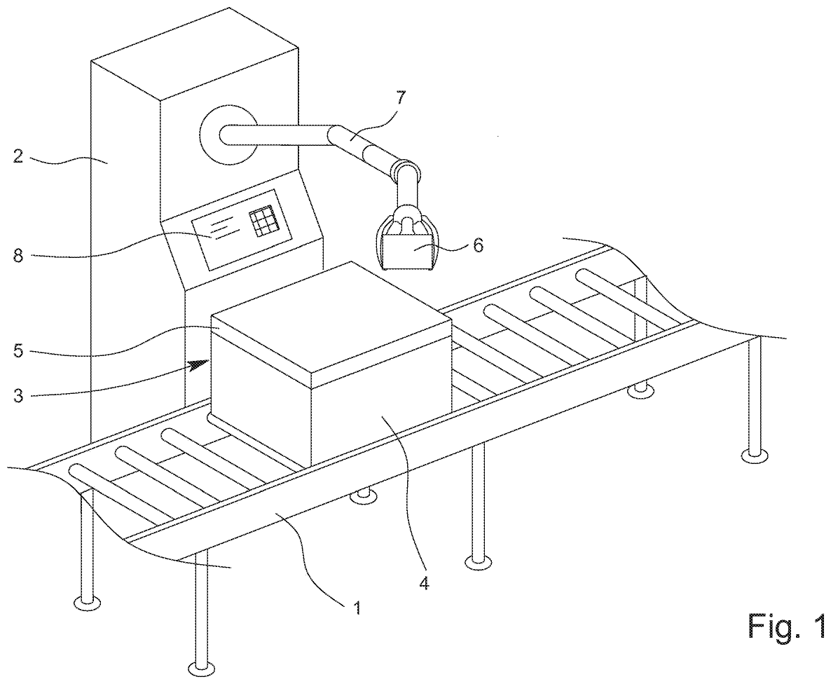

FIG. 1 shows a schematic illustration of a first exemplary embodiment of an apparatus for carrying out a method according to the invention, and

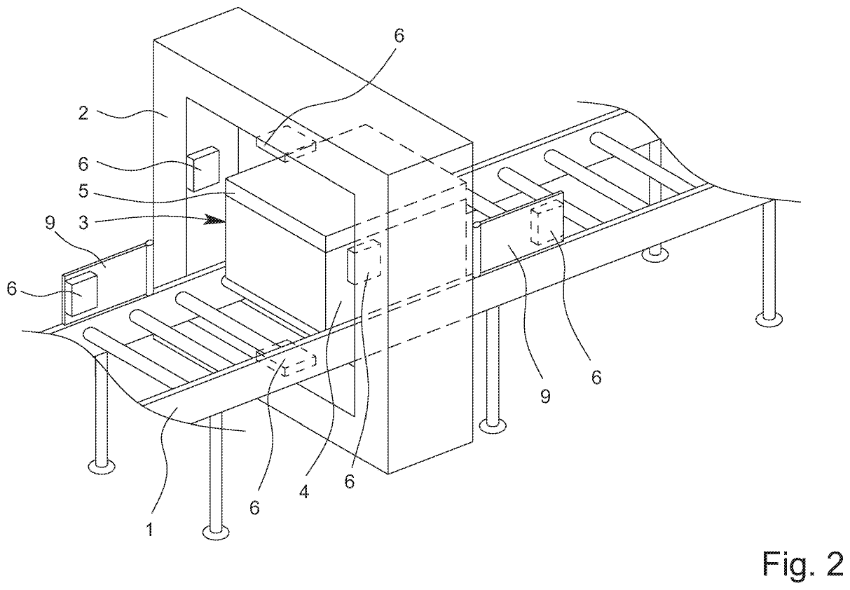

FIG. 2 shows a schematic illustration of a second exemplary embodiment of an apparatus for carrying out a method according to the invention.

FIG. 1 shows a perspective view of a transport roller track 1 on which a transport container 3 is just now situated at a checking station 2. The transport container 3 has a substructure 4 which is formed by side walls and a base and on the top of which the closing cover 5 is placed. A vacuum insulation panel is respectively situated in the side walls and the base of the substructure 4 and in the cover 5 between the outer wall and the inner container consisting in this case of foam plastic, both of which cannot be seen here.

Each vacuum insulation panel is equipped with a pressure sensor and a transponder connected to the latter. In particular, they may be a micromechanical pressure sensor and an RFID transponder or an NFC transponder. In principle, however, all pressure sensors with a different method of operation and transponders with an appropriate range which are suitable for this application can be used.

At least one reader 6, precisely one reader 6 in this case, which can be used to read the transponders of the vacuum insulation panels in the thermal insulation of the transport container 3 is situated at the checking station 2. In the preferred exemplary embodiment illustrated, the reader 6 is carried by a positioning mechanism 7, here in the form of a robot arm. Other positioning mechanisms are also possible, for example X/Y or X/Z coordinate mechanisms, in particular if a plurality of readers 6 are used.

If the transport container 3 is stationary or in any case is moving only slowly in a controlled manner on the transport roller track 1 in the checking station 2, the positioning mechanism 7 can be used to move the reader 6 in an automated and motorized manner to the total of six predefined positions relative to the transport container 3 in which a transponder of a vacuum insulation panel can be read in each case. In this exemplary embodiment, the transponders of all the vacuum insulation panels are therefore read in succession by the reader 6. For this purpose, the robot arm, which forms the positioning mechanism 7 for the reader 6, moves the reader 6 to all locations at which the response signal from a transponder of a vacuum insulation panel is intended to be captured.

The various alternatives for the configuration of the apparatus illustrated in FIG. 1 have been described within the scope of the explanation of the method. For example, it is possible to operate with two positioning mechanisms and a reader respectively fitted thereto in order to be able to carry out the reading partially at the same time.

For example, a gripping arm can also be arranged on the checking station 2, which gripping arm lifts the cover 5 from the substructure 4 of the transport container 3 and pivots the cover 5 to the side for a separate check by means of a separate reader, while a second reader plunges into the substructure 4 and simultaneously reads all transponders of the different vacuum insulation panels which are in the substructure 4.

In any case, the important factor is that an electronic control and evaluation device 8 is provided for the purpose of controlling the at least one positioning mechanism 7 and evaluating the output signals from the at least one reader 6. This is schematically indicated in FIG. 1.

It has already been pointed out further above that the transport roller track 1 has a switch, for example, downstream of the checking station 2 in the run-through direction, which switch is controlled by the control and evaluation device 8 and is used to discharge a transport container 3 in which a fault in the thermal insulation has been determined.

FIG. 2 shows another exemplary embodiment which likewise has a transport roller track 1 having a checking station 2 for a transport container 3 on the roller track 1. However, provision is made here for a plurality of readers 6 to be arranged in a frame-like or gantry-like manner on the transport track 1 for the transport containers 3, namely a reader 6 on the left and on the right as well as at the top and at the bottom. Lateral pivot arms 9 which are arranged on the checking station 2 are used to respectably pivot yet another reader 6 in front of the transport container 3 and another reader behind the transport container 3 in and out again as necessary in line with the process while the transport container is passing through.

With the design explained above according to FIG. 2, it is possible to dispense with a technically complicated robot arm as the positioning mechanism 7, rather only the two pivot arms 9 are needed here and the readers 6 moreover sit on the transport track 1 in a stationary manner.

In the exemplary embodiment explained above as well, provision may again be made for the cover 5 to be separated from the substructure 4 of the transport container 3 by means of a gripping arm or another manipulation apparatus and to then be checked separately by a reader 6.

The method according to the invention which is implemented by an apparatus designed in an appropriate manner can be used to automatically check transport containers of the type in question for the functional capability of the thermal insulation, in which vacuum insulation panels are installed, with a high throughput. The method according to the invention is particularly suitable for large-scale production.

### LIST OF REFERENCE SIGNS

1 Transport track
2 Checking station
3 Transport container
4 Substructure
5 Cover
6 Reader
7 Positioning mechanism
8 Control and evaluation device
9 Pivot arm

1. A method for checking the functional capability of the thermal insulation of a transport container,
wherein at least one vacuum insulation panel is installed in the thermal insulation of the transport container, which vacuum insulation panel
consists of a porous core material of low thermal conductivity and a gas-tight enclosure enclosing the core material in a close-fitting manner at a very low internal pressure and
has, inside the enclosure, a pressure sensor and a transponder connected to the pressure sensor,
wherein, for the checking, the transponder is controlled by an external reader from outside the thermal insulation and its response signal is captured or read and the response signal is evaluated, in order to determine whether the internal pressure in the vacuum insulation panel is correctly low or incorrectly high,
wherein
the external reader can be moved and, when the transport container is stationary or is moving in a controlled manner, is moved to a predefined position relative to the transport container in an automated and motorized manner, which position is suitable for reading the transponder,
and the response signal from the transponder is captured in this position, and
the captured response signal from the transponder is electronically evaluated in an automated manner.

2. The method of claim 1, wherein a plurality of vacuum insulation panels with a transponder are installed in the thermal insulation of the transport container, wherein the transponders of all vacuum insulation panels are read at the same time or at approximately the same time.

3. The method of claim 1, wherein a plurality of vacuum insulation panels with a transponder are installed in the thermal insulation of the transport container, wherein the transponders of all or at least a plurality of vacuum insulation panels are read in succession by the reader.

4. The method of claim 1, wherein a plurality of vacuum insulation panels with a transponder are installed in the thermal insulation of the transport container, wherein a plurality of external readers are used and the transponders of different vacuum insulation panels are simultaneously read by the readers.

5. The method of claim 1, wherein the transport container is transported relative to the reader(s) before and/or after reading the transponders of all vacuum insulation panels installed therein.

6. A method for checking the functional capability of the thermal insulation of a transport container,
wherein at least one vacuum insulation panel is installed in the thermal insulation of the transport container, which vacuum insulation panel
consists of a porous core material of low thermal conductivity and a gas-tight enclosure enclosing the core material in a close-fitting manner at a very low internal pressure and
has, inside the enclosure, a pressure sensor and a transponder connected to the pressure sensor,
wherein, for the checking, the transponder is controlled by an external reader from outside the thermal insulation and its response signal is captured or read and the response signal is evaluated, in particular in order to determine whether the internal pressure in the vacuum insulation panel is correctly low or incorrectly high,
wherein:
the external reader is arranged at a transport track for the transport container,
the transport container is moved to a predefined position relative to the reader in an automated manner, which position is suitable for reading the transponder,
the response signal from the transponder is captured in this position, and
the captured response signal from the transponder is electronically evaluated in an automated manner.

7. The method of claim 6, wherein the transport container is transported in succession in an automated manner to a plurality of different positions relative to the external reader.

8. The method of claim 6, wherein a plurality of vacuum insulation panels with a transponder are installed in the thermal insulation of the transport container, wherein
a plurality of external readers is arranged at the transport track for the transport container, and
the transponders of different vacuum insulation panels are simultaneously read by the readers.

9. The method of claim 1, wherein the transport container has a substructure and a cover which both each have at least one vacuum insulation panel with a transponder, wherein the transponders of the vacuum insulation panels of the substructure, on the one hand, and of the cover, on the other hand, are read separately from one another by means of a reader or a plurality of readers.

10. The method of claim 1, wherein use is made of transponders which, in addition to an item of yes/no information relating to the pressure in the vacuum insulation panel, provide further data, for example a measured pressure value, a serial number or another identification of the vacuum insulation panel.

11. The method of claim 10, wherein transponders having a long range, preferably a range of more than 100 cm, are used and all transponders of the vacuum insulation panels of the transport container are read together using a movable or stationary reader.

12. The method of claim 10, wherein
the transponders having a wide range, preferably a range of more than 100 cm, are used,
a plurality of transport containers are arranged together at one location, in particular are stacked, and
the transponders of the vacuum insulation panels of all transport containers arranged together at one location are read together using a movable or stationary reader or using a plurality of movable or stationary readers.

13. The method of claim 1, wherein
the transport container is identified before checking the transponders of a plurality of vacuum insulation panels of the transport container in order to determine where vacuum insulation panels are installed in the thermal insulation, and
only those positions which correspond to the identified positions of the vacuum insulation panels are then approached by the reader and/or only those readers which correspond to the identified positions of the vacuum insulation panels are activated for the purpose of checking the transponders.

14. An apparatus for carrying out a method as claimed in claim 1, comprising,
at least one reader for transponders,
at least one positioning mechanism which carries the at least one reader, in particular in the form of a robot arm, and
an electronic control and evaluation device for controlling the at least one positioning mechanism and for evaluating the output signals from the at least one reader.

15. An apparatus for carrying out a method as claimed in claim 6, comprising
a transport track for the transport container(s),
at least one reader on the transport track, and
an electronic control and evaluation device for controlling the transport track and the at least one reader and for evaluating the output signals from the at least one reader.
